(19) United States
(12) Patent Application Publication
(10) Pub. No.: US 2025/0318496 A1
(43) Pub. Date: Oct. 16, 2025

(54) APPARATUS FOR A PET RESTRAINT

(71) Applicant: Anthony Jeremiah Bayne, lomita, CA (US)

(72) Inventor: Anthony Jeremiah Bayne, lomita, CA (US)

(21) Appl. No.: 18/791,415

(22) Filed: Jul. 31, 2024

Related U.S. Application Data
(60) Provisional application No. 63/633,861, filed on Apr. 15, 2024.
(60) Provisional application No. 63/635,122, filed on Apr. 17, 2024.
(60) Provisional application No. 63/636,007, filed on Apr. 18, 2024.
(60) Provisional application No. 63/647,426, filed on May 14, 2024.

(51) Int. Cl. A01K 1/02

(52) U.S. Cl. CPC A01K 1/0272

(57) ABSTRACT

An apparatus to connect a pet restraint to a vehicle's seat belt buckle that prevents a tethered pet, such as a dog, from freeing itself by stepping on the seat belt buckle's release button and jumping out of the vehicle to its harm, or into a driver's lap and potentially causing a traffic accident to the harm of many. A user can easily disengage the apparatus from the seat belt buckle with a push of a finger to the seat belt buckle's release button.

### FIELD OF THE INVENTION

The present invention relates to a safety apparatus. More particularly, the present invention relates to an improved safety apparatus for securing a pet restraint to a vehicle's safety belt buckle to prevent a tethered pet from getting free.

### BACKGROUND OF THE INVENTION

People often transport their pet dog in the back seat of their vehicle (e.g., a car). To keep the dog from jumping out of a car window, or coming into the driver's cabin, an owner may use a vehicle pet restraint to tether the dog to the car's back seat belt buckle.

A pet restraint, also referred to as a “pet restraint assembly”, often includes a length (e.g., 36 inches) of flexible material (e.g., nylon webbing, chain, or PVC covered “steel rope”) with two ends. The first end of the restraint length often includes a “T-shaped” metal seat belt buckle tongue, also known as a “latch plate”, that is pushed into a seat belt buckle insert hole to secure the pet restraint to the seat belt buckle. A connecting device (e.g., a bolt snap) is attached to the second end of the length of flexible material to removably attach to a metal ring of a dog's collar/harness.

A problem with current pet restraints is that they do not prevent a dog from stepping on the buckle's release button and freeing itself to come into the driver's cabin and disrupt the driver, which may cause an accident, or to jump out of a window to its harm.

To prevent a child from releasing itself, RELEASE RESISTANT BUCKLE COVER, U.S. Pat. No. 6,332,252 B1, Diana L. Powers, teaches a release resistant buckle cover (for children) that teaches gaps “sized not to allow access to the release button by a finger”, and requires the use of an object to operate the release of a seat belt buckle.

Saker Canine's “Buckle P'up Buckle Protector” www.sakercanine.com sells a device that fits over a car's seat belt buckle to prevent a dog from depressing the release. However, it too requires a tool to stick through the “top hole” of the device to operate the release. A tutorial on the website suggests using “a key” to release a seat belt buckle from the device.

Another problem is that when a pet restraint is a “no-chew” type pet restraint, made of steel rope or chain, the length is not easily adjustable.

Therefore, there remains a need to provide a no-chew pet restraint that is easily adjustable, prevents a dog from stepping on an attached seat belt buckle's release button, and may be released without a tool.

### SUMMARY OF THE INVENTION

To overcome the aforesaid deficiencies in prior pet restraints and pet buckle covers, disclosed is a new seat belt buckle cover apparatus for a pet restraint that prevents a tethered dog from stepping on a seat belt buckle release, allows a user to easily release the pet restraint from an attached to a seat belt buckle with a push of a finger (i.e., no supplementary tool is required), and makes a length of a no-chew restraint easily adjustable.

In a preferred embodiment the invention comprises an apparatus for a pet restraint. The apparatus further comprises a latch plate that includes a first hole, and a cover that extends at least partially over the latch plate. The apparatus further comprises a second hole to attach a pet restraint (i.e. the long flexible length portion of a pet restraint assembly). In use, the cover also extends at least partially over an attached seat belt buckle's release button to prevent a pet from stepping on it and releasing itself. The apparatus further includes a wall, or other supporting means, to support the cover in such a way that when the latch plate is pushed into a seat belt buckle's insert hole to attach the apparatus, a space exists between the seat belt buckle and the cover that allows a user to reach under the cover with a finger to depress the seat belt buckle's release button and disengage the apparatus from the seat belt buckle. The apparatus may additionally include a third hole located between the first hole and the second hole to thread a pet restraint's flexible length (e.g., steel rope) and connecting device (e.g., bolt snap) through the third hole, so that the flexible length can be wrapped around the apparatus to adjust the pet restraint's length (e.g., by shortening it). When there is no third hole, the second hole may be large enough to allow the restraint's length and connecting device to be thread through the second hole and wrapped around the apparatus to adjust the pet restraint's length. In an alternate embodiment of the apparatus, the apparatus may have no hole large enough to adjust a pet restraint's length. In this alternate embodiment, the second hole is only used to attach a first end of the pet restraint to it.

In alternate embodiment, the invention comprises a pet restraint assembly, the pet restraint assembly further comprising a length of flexible material that includes a first end and second end, a connecting device (e.g., bolt snap) secured to the second end of the length of flexible material that is removably attachable to a pet's garment; and an apparatus secured to the first end of the length of flexible material, wherein the apparatus further comprises a latch plate to connect the pet restraint assembly to a seat belt buckle, a cover that extends at least partially over an attached seat belt buckle to prevent a pet from stepping on a release button of the seat belt buckle. The latch plate includes a first hole. The apparatus further includes a second hole to connect the first end of the length of flexible material. Additionally, the second hole may be large enough to allow the connecting device and the length of flexible material to be thread through the second hole and wrapped around the apparatus to adjust the pet restraint assembly's length.

In an additional alternate embodiment, the invention includes an apparatus for a pet restraint, comprising a latch plate that includes a first hole, a cover that extends at least partially over the latch plate; and a wall that partitions the latch plate from a second hole that is used to connect the pet restraint (i.e., the pet restraint's first end of a length of flexible material). Additionally, the second hole may be large enough to allow a connecting device (e.g., a bolt snap attached to a second end of the flexible material) and the flexible material to be threaded through the second hole and wrapped around the apparatus to adjust (e.g., shorten) its length. The partitioning wall may include a hole that is large enough for an adult male user to stick a finger through the finger hole to push a seat belt buckle's release button to disconnect the apparatus from an attached seat belt buckle. Alternatively, the partitioning wall may have no hole, but instead be spaced from the latch plate's first hole, so that when the apparatus is attached to a seat belt buckle a gap exists to allow a user to reach a finger behind the partitioning wall and push the buckle's release button.

In yet another alternate embodiment, the invention includes an apparatus to cover a release button of a seat belt buckle, comprising a cover that, in use, extends at least partially over a release button of a seat belt buckle; and a first hole that substantially aligns with an insert hole of the seat belt buckle to receive a latch plate of a pet restraint assembly to be pushed through the first hole and into the seat belt buckle's insert hole to attach the cover and the pet restraint to the seat belt buckle. The cover is preferably constructed of a rigid material such as metal, plastic, or a combination of them (e.g., metal injection molding), but can be made of any suitable rigid material that will support a medium sized dog's weight when a dog steps on it to prevent the cover from crushing down and depressing a buckle's release button. The cover may include a second, larger hole located above the first hole that is large enough to allow an adult male user to stick a finger through the second hole and push the release button of the seat belt buckle to disengage an attached pet restraint assembly. Alternatively, or in addition to the second hole, the cover may be configured to include a gap between the seat belt buckle (top and/or front surface of the buckle) and the inner surface of the cover (i.e., the buckle facing side of the cover), so that when it is attached to the buckle, sufficient room exists for a user to reach under/behind the cover and press the seat belt buckle's release button with a finger to disengage an attached pet restraint assembly.

Other objectives and aspects of the invention will become apparent from the following detailed description, taken in conjunction with the accompanying drawings, which illustrate, by way of example, the features in accordance with embodiments of the invention.

To the accomplishment of the above and related objects, the invention may be embodied in the form illustrated in the accompanying drawings, attention being called to the fact, that the drawings are illustrative only, and that changes may be made in the specific construction illustrated, and the manner described, that are within the scope of the appended claims.

For example, current latch plates have a hole, if later latch plates are developed without a hole, then modifications to allow for this development are intended to be included with the scope of the disclosure herein. Thus, the breadth and scope of the present invention should not be limited by any of the above-described exemplary embodiments.

### BRIEF DESCRIPTION OF THE DRAWINGS

FIG. 1 shows a perspective view of a preferred embodiment of the pet restraint apparatus.

FIG. 2 shows a bottom view of the apparatus of FIG. 1.

FIG. 3 shows a top view of the apparatus of FIG. 1.

FIG. 4 shows a left-side view of the apparatus of FIG. 1.

FIG. 5 shows a right-side view of the apparatus of FIG. 1.

FIG. 6 shows a back view of the apparatus of FIG. 1.

FIG. 7 shows a front view of the apparatus of FIG. 1.

FIG. 8 shows the apparatus of FIG. 1 as a component of a pet restraint assembly.

FIG. 9 shows the apparatus of FIG. 1 as a component of a pet restraint assembly in use.

FIG. 10 shows an elevated perspective view of an alternate embodiment of a pet restraint apparatus.

FIG. 11 shows a back view of the apparatus of FIG. 10.

FIG. 12 shows a front view of the apparatus of FIG. 10.

FIG. 13 shows a top view of the apparatus of FIG. 10.

FIG. 14 shows an elevated perspective view of an alternate embodiment of a cover for a pet restraint.

FIG. 15 shows a top view of FIG. 14.

FIG. 16 shows a right-side view of FIG. 14.

FIG. 17 shows the apparatus of FIG. 14 attached to a seat belt buckle by a latch plate of a pet restraint.

### DETAILED DESCRIPTION OF THE INVENTION

The present invention solves the aforesaid problems by providing a new seat belt buckle cover apparatus for a pet restraint assembly that prevents a pet (e.g., dog) from accidentally releasing itself to its harm and/or the harm of the driver, as well as allowing the pet owner to easily release the pet restraint with a push of a finger. These and other features, aspects and embodiments of the invention will be described in more detail below.

The presence of broadening words and phrases such as “one or more,” “at least,” “but not limited to”, or other like phrases, shall not be read to mean that the narrower case is intended, or required, where such broadening phrases may be absent.

The following detailed description is directed to certain specific embodiments of the invention. However, the invention can be embodied in a multitude of diverse ways as defined and covered by the claims. In this description, reference is made to the drawings wherein like parts are designated with like numerals throughout.

The objects and features of the present invention will become more fully apparent from the following description and appended claims, taken in conjunction with the accompanying drawings. Understanding that these drawings depict only typical embodiments of the invention and are not to be considered limiting of its scope, the invention will be described and explained with additional specificity and detail using the accompanying drawings.

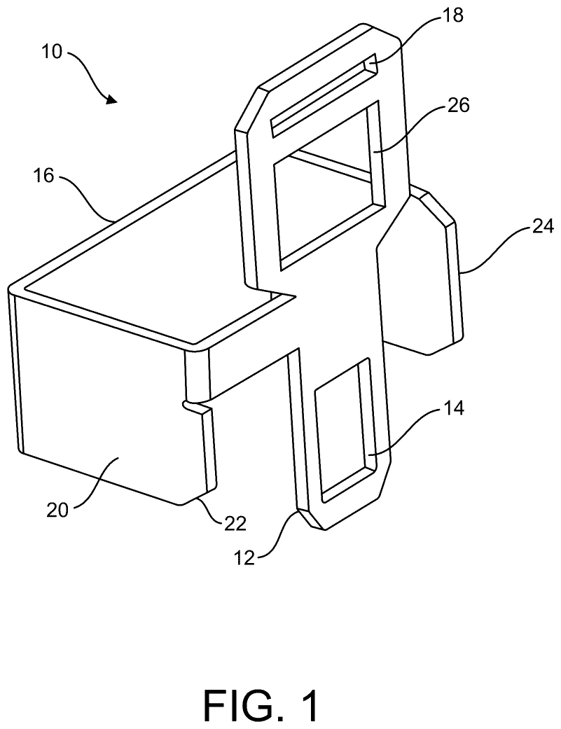

FIG. 1 Shows a perspective view of a preferred embodiment of the pet restraint apparatus 10. The apparatus 10 includes a latch plate 12 that further includes a first hole 14. The apparatus 10 also includes a cover 16 that extends at least partially over the latch plate 12. The apparatus 10 also includes a second hole 18 to attach a first end of a pet restraint.

The distance of the cover 16 from the latch plate 12 creates a space to allow a user to reach under the cover 16 with a finger and press a seat belt buckle's a release button when the apparatus's 10 latch plate 12 is attached to the seat belt buckle. The apparatus 10 further comprises a first wall 20 that supports the cover 16 and may be substantially perpendicular to the latch plate 12. The first wall 20 may have one or more chamfered corners 22 to prevent the apparatus 10 from scratching a car seat's upholstery. The apparatus 10 may include a second wall 24 to prevent a pet's paw from sliding under the cover 16. The apparatus 10 in FIG. 1 is preferably formed of a unitary one-piece construction (e.g., no weld). However, the apparatus 10 may be made of two or more pieces of material (e.g., steel) that are welded together, or joined by some other means (e.g., connected by fasteners, snapped together, etc.).

The apparatus may include a third hole 26 located between the first hole 14 and second hole 18. When the apparatus includes a third hole 26, it is large enough to thread a pet restraint's length (e.g., chain) and attached connecting device (e.g., bolt snap) through the third hole 26 and wrapped around the apparatus 10 to adjust the restraint's length. When the apparatus 10 has no third hole 26, then the second hole 18 may be large enough to allow the length and connecting device of a pet restraint to be threaded through the second hole 18 and wrapped around the apparatus 10 to adjust the restraint's length.

In a preferred embodiment, the apparatus 10 will be constructed of a rigid material, such as metal (e.g., iron, aluminum, etc.), to prevent a dog from chewing and destroying the apparatus 10. Further, an apparatus 10 made of metal will support a large dog's weight and prevent the dog from crushing the cover 16 onto the seat belt buckle's release button. The apparatus 10 may be formed by folding a suitably shaped piece of flat metal (that has the first hole 14, and a second hole 18 in the flat metal) to form the apparatus 10 and it's cover 16.

Alternatively, the apparatus 10 may be constructed of a suitable synthetic material (e.g., plastic) when the apparatus 10 is for a small pet (e.g., a toy size dog, like a Pomeranian) that cannot easily destroy the apparatus 10 by chewing it, or is so light, that it cannot collapse a plastic (for example) cover 16 by stepping on it and releasing itself.

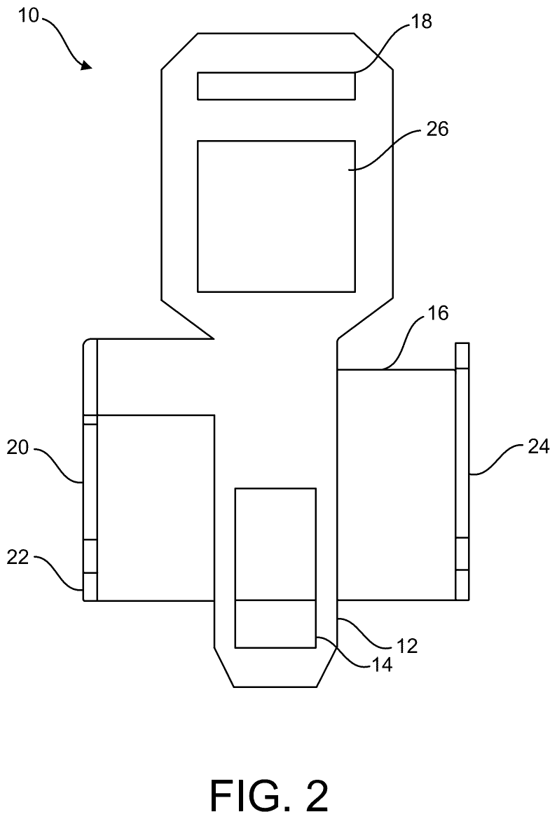

FIG. 2 shows bottom view of the apparatus 10 in FIG. 1, comprising a latch plate 12 that further includes a first hole 14. The latch plate 12 is pushed into a seat belt buckle's insert hole to attach the apparatus 10 to the seat belt buckle. The apparatus 10 further comprises a cover 16, a second hole 18, a first wall 20 (that may have a chamfered corner 22). The apparatus 10 may include a third hole 26 between the first hole 14 and second hole 18, that is used to adjust a pet restraint's length by threading the restraint through the third hole 26 and around the apparatus 10. The distance of the cover 16 from the latch plate 12 creates a space that is large enough to allow a user to reach under the cover 16 with a finger and push a seat belt buckle's release button to disengage an attached apparatus 10 from a seat belt buckle.

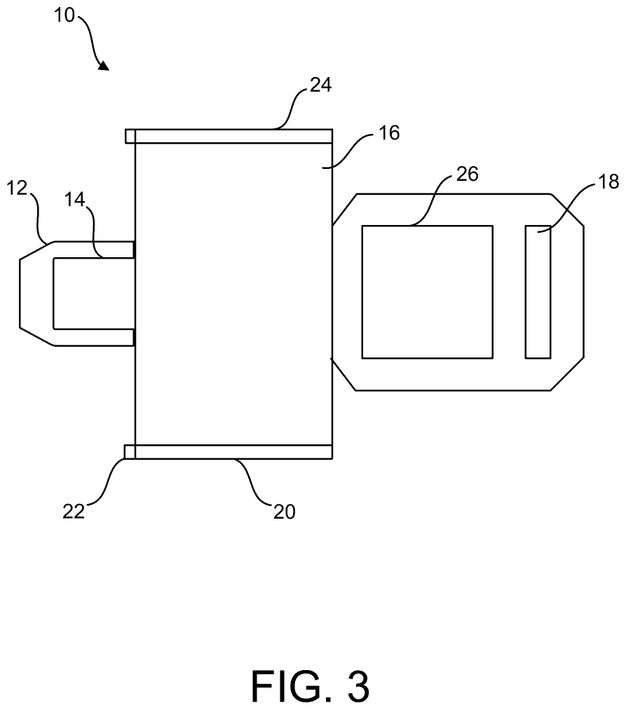

FIG. 3 shows a top view of the apparatus 10 in FIG. 1. The cover 16 extends at least partially over the latch plate 12. The first wall 20 may include one or more chamfered corners 22 to prevent damage to a car seat. The apparatus 10 includes a second hole 18 and may include a third hole 26 between the first hole 14 and the second hole 18. When the apparatus has no third hole 26, the second hole 18 may be large enough to allow a pet restraint's length and connecting device (e.g., snap hook) to thread through the second hole 18 and wrap around the apparatus 10 adjust the restraint's length. Essentially, the second hole 18 may be used to as a third hole 26 when a third hole 26 is absent. The apparatus 10 may include a second wall 24 to prevent a pet's paw sliding under the cover 16.

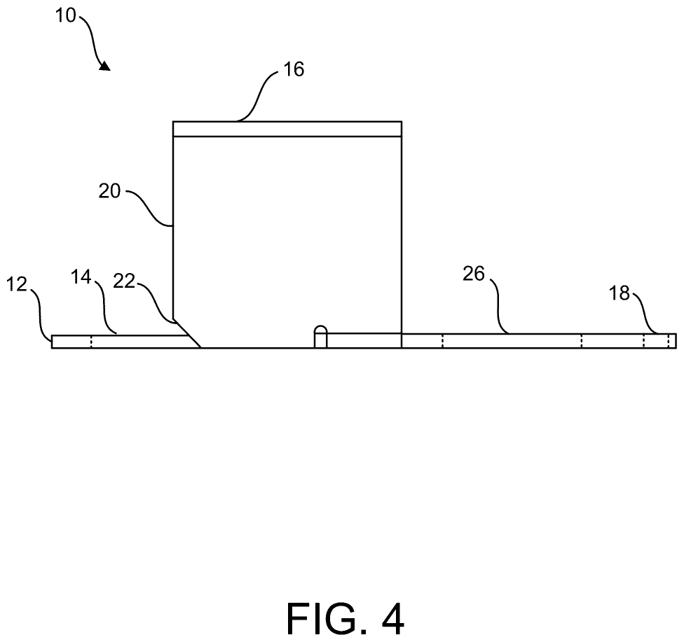

FIG. 4 shows a left side view of the apparatus 10 in FIG. 1, including a latch plate 12, a first hole 14, a cover 16, a second hole 18, a first wall 20 with a chamfered corner 22, and a third hole 26. The cover's 16 distance from the latch plate 12 creates a space that permits a user to reach under the cover 16 with a finger to push a seat belt buckle's release when the apparatus 10 is attached to a seat belt buckle.

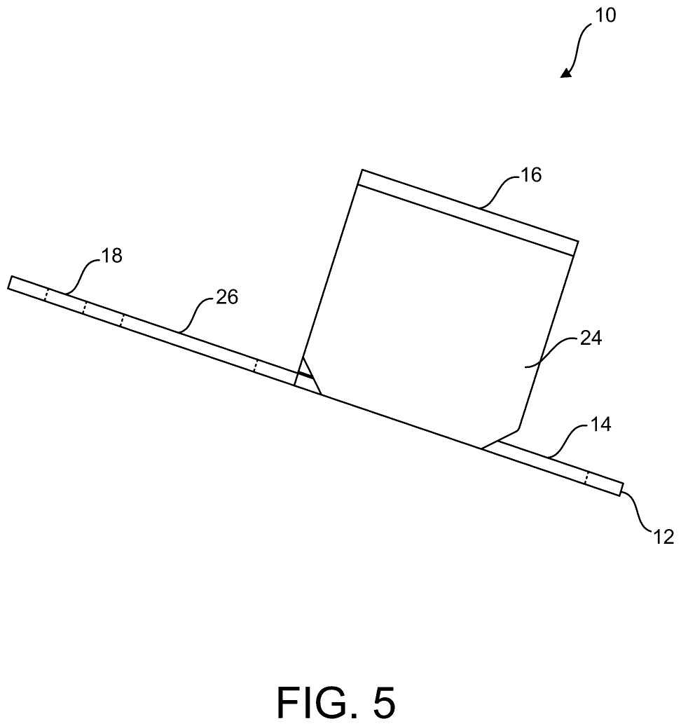

FIG. 5 shows a right-side view of the apparatus 10 in FIG. 1, comprising a latch plate 12, that includes a first hole 14. A cover 16 that at least partially covers the latch plate 12 and the first hole 14. The apparatus 10 further comprises a second hole 18 and may include a third hole 26 between the first hole 14 and the second hole 18. The apparatus 10 may include a second wall 24 to prevent a pet's paw from sliding under the cover 16.

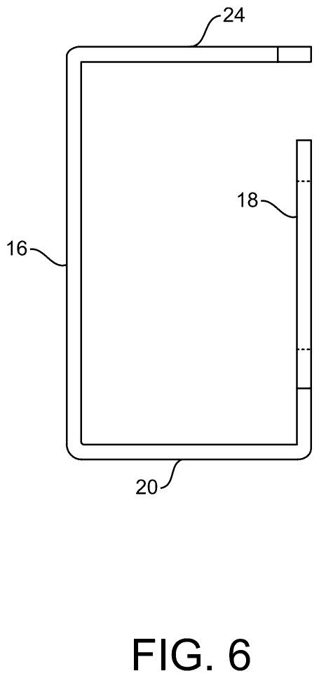

FIG. 6 shows a back view of the apparatus 10 in FIG. 1. The cover 16 is supported by a first wall 20. The cover 16 prevents a pet (e.g., a dog) from stepping on a seat belt buckle's release button when the apparatus 10 is attached to the buckle. The first wall 20 holds the cover 16 at a height above the latch plate 12 to create a space large enough to allow a user to reach under the cover 16 with a finger and press an attached seat belt buckle's release button. A second hole 18 is used to attach a pet restraint. Additionally, when there is no third hole 26, the second hole 18 may be used to thread a pet restraint through it and wrapped around the apparatus 10 to adjust the restraint's length. The apparatus may include a second wall 24 to prevent a pet's paw from sliding under the cover 16.

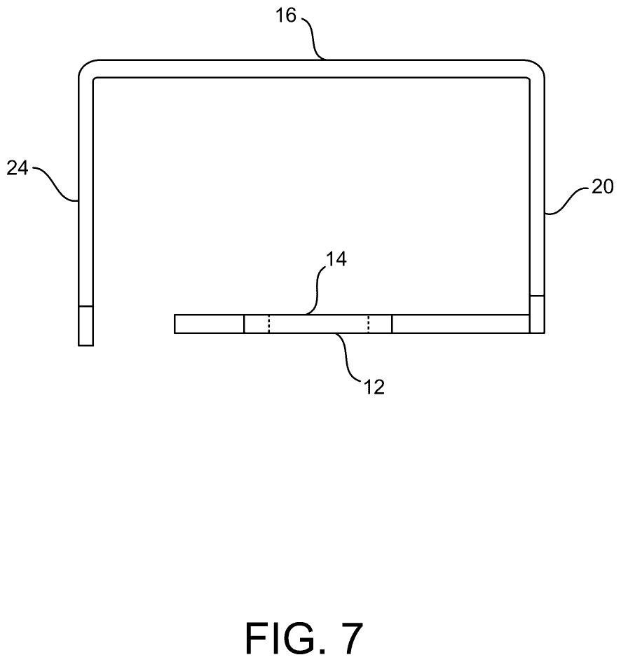

FIG. 7 shows a front view of the apparatus 10 in FIG. 1, comprising a latch plate 12, a first hole 14, a first wall 20, a second wall 24 and a cover 16. The cover 16 extends at least partially over the latch plate 12. The distance between the latch plate 12 and cover 16 creates a space to allow a user to reach under the cover 16 and press a release button of an attached seat belt buckle.

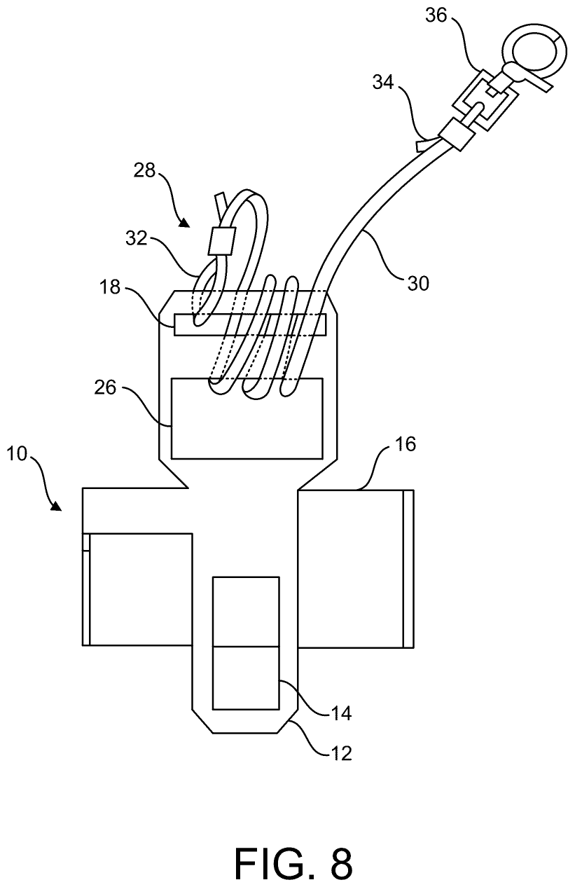

FIG. 8 shows a bottom view of the apparatus 10 in FIG. 1 as part of a no chew pet restraint assembly 28. The pet restraint assembly 28 comprises a length of flexible material 30 that includes a first end 32 and a second end 34, a connecting device 36 secured to the second end 34 of the length of flexible material 30 that is removably attachable to a pet's garment (e.g. a ring of a dog collar or harness); and an apparatus 10 secured to the first end 32 of the length of flexible material 30 that is used to connect the pet restraint assembly 28 to a vehicle's seat belt buckle (not shown) to tether a pet on a vehicle's seat. The apparatus 10 further comprises a cover 16 that at least partially extends over a latch plate 12 and, in use, at least partially over an attached seat belt buckle. The apparatus 10 prevents a pet from stepping on the release button of the seat belt buckle and freeing itself.

The pet restraint assembly's 28 length of flexible material 30 is shown attached to the apparatus 10 at the second hole 18 and threaded through the third hole 26 and wrapped around the apparatus 10. The pet restraint assembly's 28 length is adjusted by wrapping it/unwrapping it, bringing the connecting device 36 closer/further to the apparatus 10. This would be useful, for example, when an owner wants to allow a restrained pet dog to be able to stick it's head out of a car's rear window but does not want the dog to be able to get out of the window any further. The apparatus 10 makes a no-chew type of pet restraint assembly 28 that utilizes steel rope or chain, easily adjustable. Because a big dog can quickly chew through a nylon restraint, a no-chew pet restraint assembly 28 is often used to transport big dogs. Further, because of its weight, it is a bigger dog that can most easily release itself by accidentally stepping on a seat belt buckle's release. The apparatus 10 prevents this. However, the apparatus 10 may be used for other types of pet restraint assemblies (e.g. nylon, rope, etc.) when an owner wants an extra level of pet anchoring protection for a small dog.

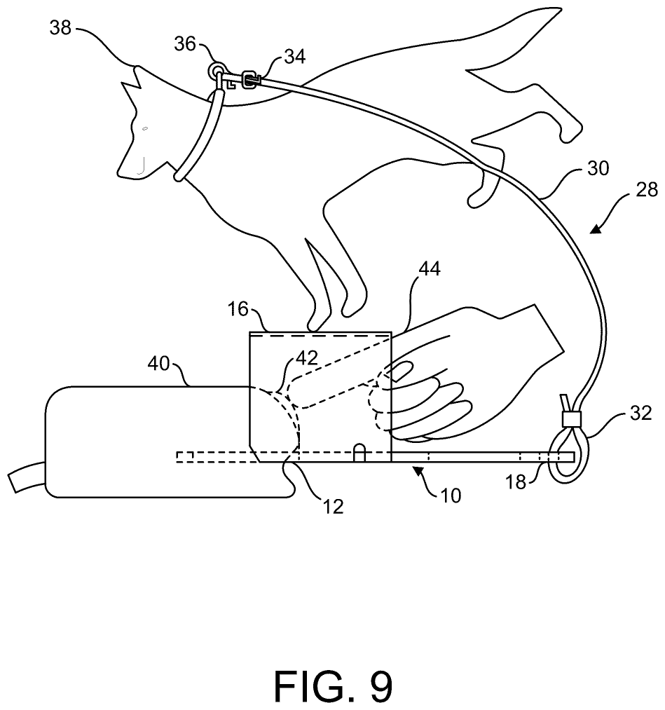

FIG. 9 shows a (not to scale) left side view of the apparatus 10 in FIG. 1 as part of a pet restraint assembly 28 in use. A dog 38 is attached to the no-chew pet restraint assembly 28 by a connecting device 36 (i.e., a bolt snap) that is attached to the second end 34 of a length of flexible material 30 of the assembly 28. The first end 34 is connected to the second hole 18 of the apparatus 10. The latch plate 12 of the apparatus 10 is inserted into a seat belt buckle 40 to connect the restraint assembly 28 and tether the dog 38.

The cover 16 prevents the dog 38 from stepping on the seat belt buckle's 40 release button 42. The cover 16 is above the latch plate 12 at a height to allow a user to stick a finger 44 under the cover 16 to push the release button 42 to detach the pet restraint assembly 28 from the seat belt buckle 40.

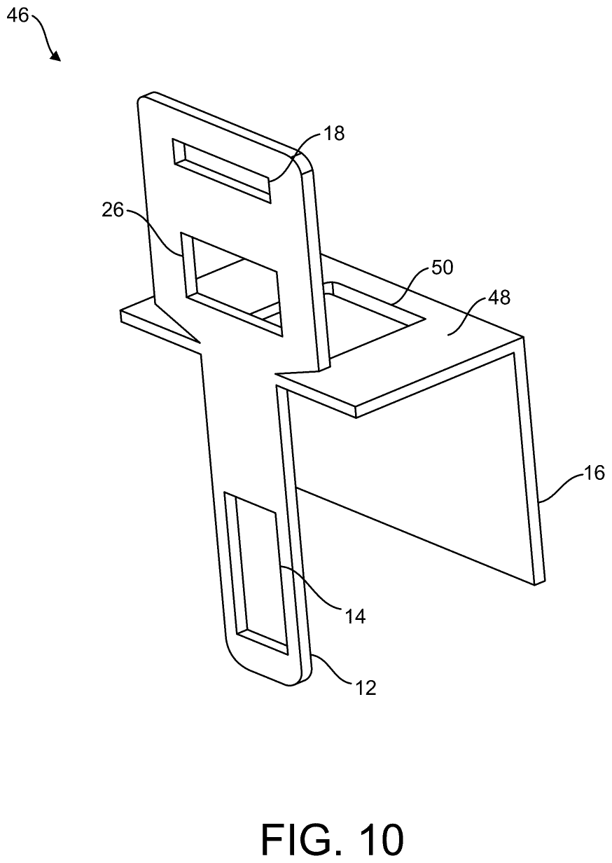

FIG. 10 shows an elevated perspective view of an alternate embodiment of a pet restraint apparatus 46. The alternate embodiment 46 includes a partitioning wall 48 that separates the latch plate 12 and first hole 14 from the second hole 18 (and a third hole 26 when one is included). The partitioning wall 48 also preferably includes a fourth hole (i.e., a finger hole) 50 that is large enough to allow an adult male user to stick a finger 44 through the fourth hole 50 to push a seat belt buckle's release button (not shown) when the apparatus 46 is attached to a seat belt buckle. The fourth hole 50 is not large enough to allow the paw of a medium-sized dog (e.g., a dog that weighs at least twenty-four pounds) to fit through the fourth hole 50. Additionally, the cover 16 is at a height above the latch plate 12 to create a space sufficient to allow a user to stick a finger 44 under the cover 16 when it is attached to a seat belt buckle to press the seat belt buckle's release button (not shown).

While it is preferable that the alternate embodiment 46 be made of a single piece of material (e.g., via metal injection molding), it alternatively may be constructed of two or more pieces joined together (e.g., by welding, fasteners, etc.).

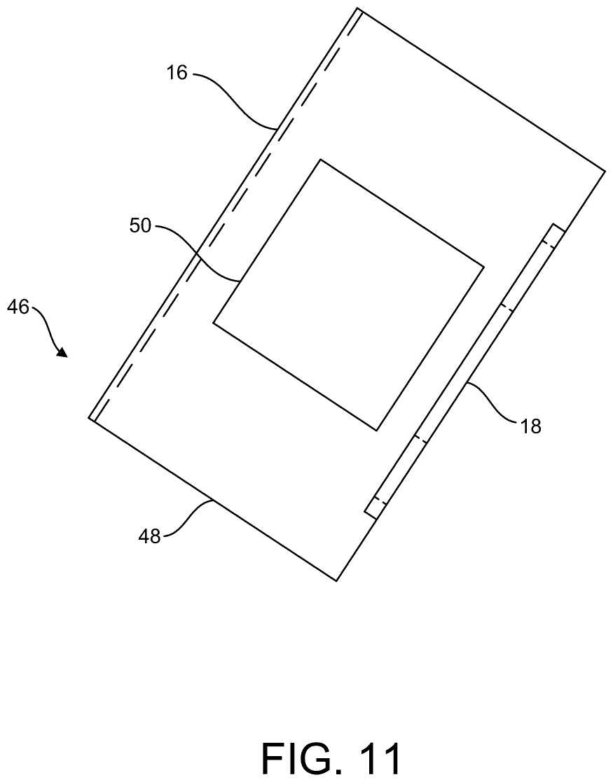

FIG. 11 shows a back view of the apparatus 46 in FIG. 10. The partitioning wall 48 includes a fourth hole 50. The second hole 18 is substantially in line with the fourth hole 50. Preferably the cover 16 and partitioning wall 48 is of a unified one-piece construction.

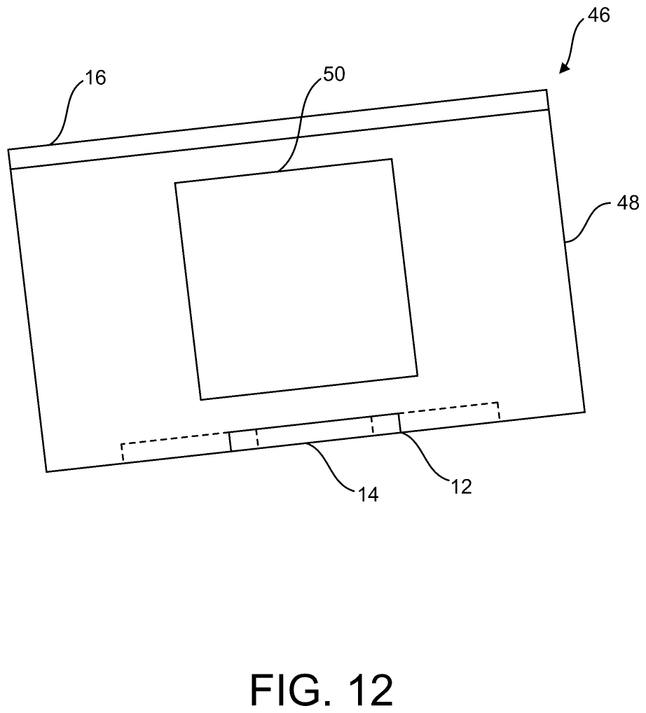

FIG. 12 shows a front view of the apparatus 46 of FIG. 10. The partitioning wall 48 includes a fourth hole 50 and divides the latch plate 12 (and first hole 14) from the second hole 18. The cover 16 extends over at least a portion of the latch plate 12.

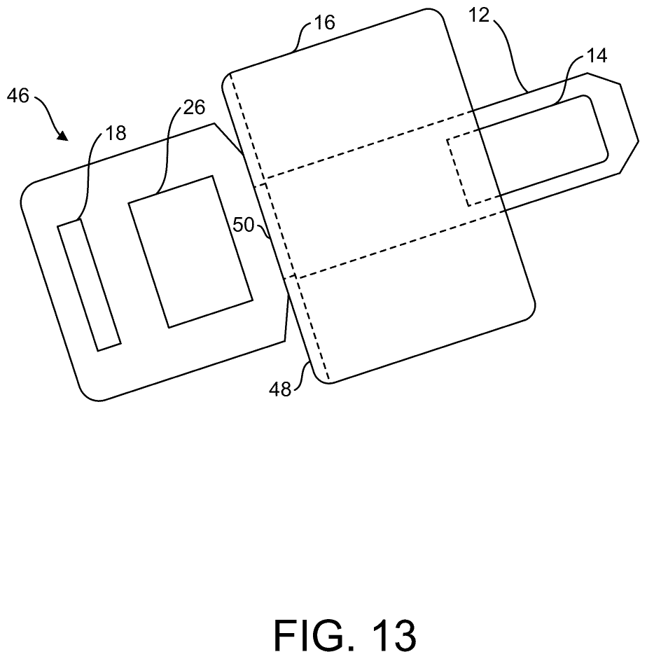

FIG. 13 shows a top view of the apparatus 46 in FIG. 10. The apparatus 46 comprises a latch plate 12 that includes a first hole 14, a cover 16 that extends at least partially over the latch plate 12, a second hole 18; and a partition wall 48 that partitions the latch plate 12 and first hole 14 from the second hole 18. The apparatus 46 may include a third hole 26 to use for adjusting the flexible length 30 of an attached pet restraint 28 (not shown). The partitioning wall 48 includes a fourth hole 50 that in use substantially aligns with a seat belt buckle's release button.

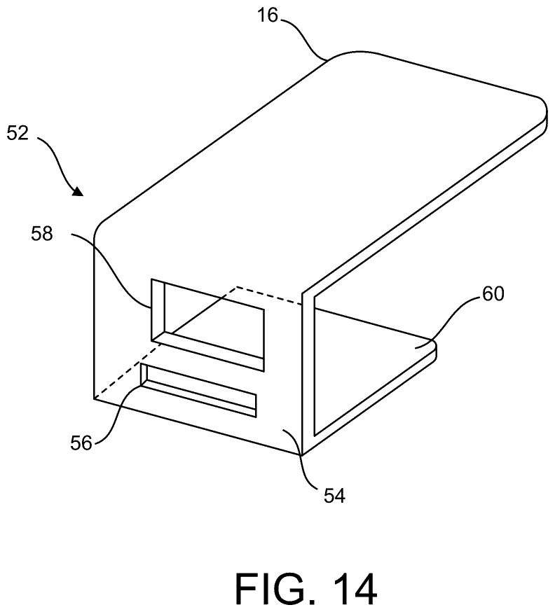

FIG. 14 shows an elevated perspective view of an alternate embodiment of a seat belt buckle cover apparatus 52 for use with a pet restraint 28 (not shown). The apparatus 52 comprises a cover 16 and a forward wall 54. The cover 16, in use, extends at least partially over a release button 42 of a seat belt buckle 40. The forward wall 54 further comprises a narrow first hole 56 that, in use, substantially aligns with a latch plate hole of the seat belt buckle. The first hole 56 receives a latch plate 12 of a pet restraint assembly 28 (not shown) to secure the cover apparatus 52 and the pet restraint assembly 28 to a seat belt buckle 40 (not shown). The forward wall 54 may further comprise a larger second finger hole 58 for a user to reach through the finger hole 58 and press a release button 42 of the seat belt buckle 40 with a finger 44. The forward wall 54 and cover 16 are preferably of a unitary, one-piece construction.

The second (finger) hole 58 is optional when the cover apparatus 52 is configured to create a space between the inner surface of the cover 16 and the outer surface of a seat belt buckle 40 sufficient to allow a user to reach under the cover 16 and press the buckle's release button 42 (not shown).

The apparatus 52 may include a base 60 that is of a unitary, one-piece construction with the apparatus 52 to support the cover 16 and prevent the cover 16 from being crushed onto a seat belt buckle's release button 42 when a pet steps on the cover 16.

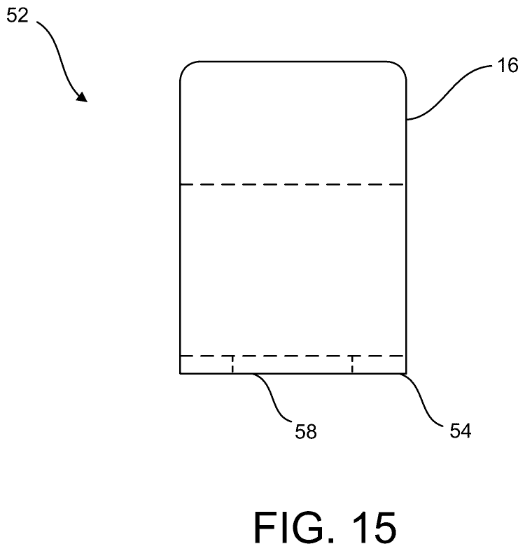

FIG. 15 shows a top view of the cover apparatus 52 in FIG. 14, comprising a cover 16, and a forward wall 54 that further comprises a first hole 56 (not shown) to receive a latch plate 12 of a pet restraint. 28 The apparatus 52 may include a second hole 58 for a user to stick a finger 44 through and press a release button 42 of an attached seat belt buckle 40.

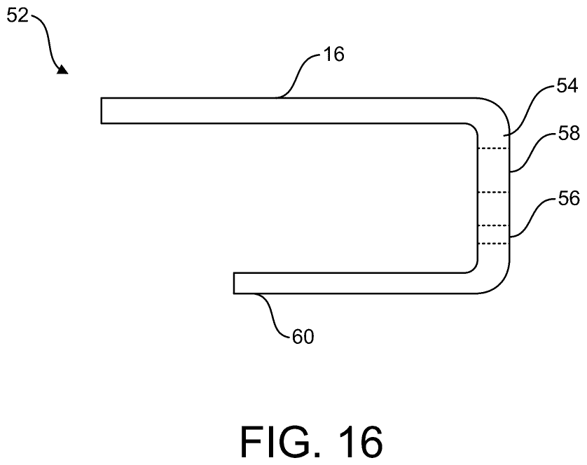

FIG. 16 shows a right-side view of the cover apparatus 52 in FIG. 14, comprising a cover 16, a forward wall 54 that further comprises a first hole 56, and a second hole 58. The second hole 58 is larger than the first hole 56 and is located above the first hole 56. The apparatus 52 may include a base 60 to stabilize the apparatus 52 and support the cover 16.

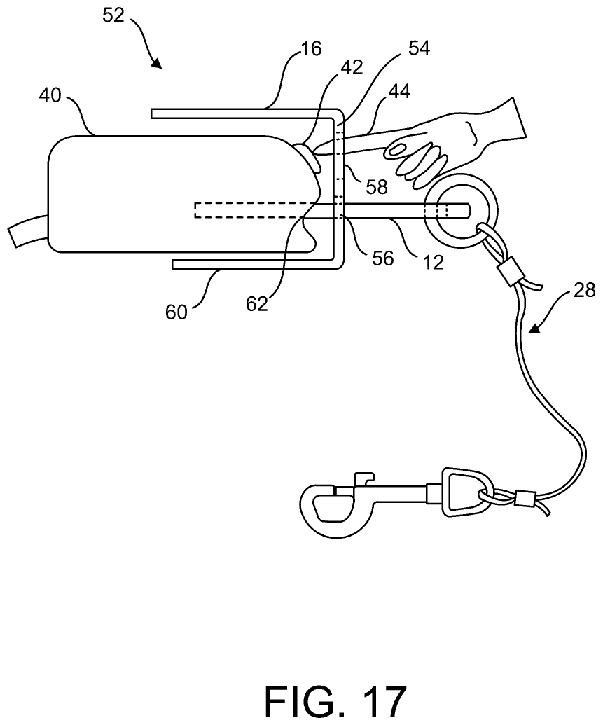

FIG. 17 shows a right-side view of the cover apparatus 52 in FIG. 14 attached to a seat belt buckle 40 using a latch plate 12 of a pet restraint assembly 28. The restraint assembly 28 includes a latch plate 12 at a first end 32 of the restraint assembly 28 that is inserted through the first hole 56 of the apparatus 52 and into a seat belt buckle's insert hole 62 to hold both the cover apparatus 52 and the restraint assembly 28 to the seat belt buckle 40. The apparatus 52 includes a larger second hole 58 that allows a user to stick a finger 44 through the second hole 58 and push a release button 42 of the seat belt buckle 40 to detach an attached restraint assembly 28. The second hole 58 is located above the first hole 56.

The cover apparatus 52 may include a base 60 to lessen the movement of the apparatus 52 and support the cover 16.

Therefore, it must be understood that the illustrated embodiments have been set forth only for the purposes of examples and that they should not be taken as limiting the invention as defined by the following claims. For example, notwithstanding the fact that the elements of a claim are set forth below in certain combination, it must be expressly understood that the invention includes other combinations of fewer, more, or different ones of the disclosed elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted, and what incorporates the essential idea of the invention.

I claim:

1. An apparatus, comprising:
an apparatus for a pet restraint,
the apparatus further comprising a latch plate that includes a first hole,
a cover that extends at least partially over the latch plate, and
a second hole.

2. The latch plate and cover of claim 1, further comprising a unitary, one-piece construction.

3. The apparatus of claim 1, further comprising a space between the latch plate and the cover to allow a user to reach under the cover with a finger to press a release button of an attached seat belt buckle to disengage the apparatus from the seat belt buckle.

4. The apparatus of claim 1, further comprising a wall that supports the cover over the latch plate.

5. The second hole of claim 1, wherein the second hole is used to connect the apparatus to a first end of a length of flexible material of a pet restraint.

6. The second hole of claim 5, further comprising a size large enough to allow a connecting device attached to a second end of the pet restraint's flexible material and the flexible material to be threaded through the second hole and wrapped around the apparatus to adjust the length of the flexible material.

7. The apparatus of claim 1, further comprising a third hole.

8. The third hole of claim 7, further being located between the first hole and the second hole.

9. The third hole of claim 8, further comprising a size large enough to allow a connecting device attached to a second end of the pet restraint's flexible material and the flexible material to be threaded through the third hole and wrapped around the apparatus to adjust the length of the flexible material.

10. The apparatus of claim 1, further being constructed of metal, a synthetic material, or a combination of materials.

11. An apparatus, comprising:
a pet restraint assembly,
the pet restraint assembly further comprising a length of flexible material that includes a first end and second end,
a connecting device secured to the second end of the length of flexible material that is removably attachable to a pet's garment; and
an apparatus secured to the first end of the length of flexible material, wherein the apparatus further comprises a latch plate to attach the pet restraint assembly to a seat belt buckle, a cover that extends at least partially over the seat belt buckle to prevent a pet from stepping on a release button of an attached seat belt buckle when the pet restraint assembly is attached to the seat belt buckle.

12. The apparatus of claim 11, further comprising a hole that is large enough to allow the flexible material and the connecting device to be threaded through the hole and wrapped around the apparatus to adjust the assembly's length.

13. An apparatus, comprising:
an apparatus for a pet restraint,
the apparatus further comprising a latch plate that includes a first hole,
a second hole to connect a first end of the pet restraint; and
a wall that partitions the latch plate from the second hole.

14. The wall of claim 13, wherein the wall at least partially blocks a seat belt buckle's release button when the apparatus is attached to a seat belt buckle.

15. The wall of claim 13, further comprising a finger hole that is large enough to allow a user to insert a finger through the finger hole to press a release button of an attached seat belt buckle to detach the apparatus from the seat belt buckle.

16. The apparatus of claim 13, further comprising a cover that extends at least partially over the latch plate.

17. An apparatus for a pet restraint, comprising:
a cover that extends at least partially over a release button of an attached seat belt buckle; and
a first hole that substantially aligns with an insert hole of the seat belt buckle to receive a latch plate of a pet restraint that is pushed through the first hole and into the seat belt buckle's insert hole to secure both the cover and the pet restraint to the seat belt buckle.

18. The cover of claim 17 further including a larger second hole located above the first hole that is large enough to allow an adult user to stick a finger through the second hole to push the release button of the seat belt buckle to release an attached pet restraint.

19. The cover of claim 17, further comprising a gap between the seat belt buckle and an inner surface of the cover to allow a user to press the release button of the seat belt buckle with a finger when the cover is held to the buckle by the latch plate.

20. The apparatus of claim 17, further comprising a base, where in the base prevents the cover from being pushed down on a seat belt buckle's release button by a paw of a pet that has stepped on the cover.
